(19) United States
(12) Patent Application Publication
(10) Pub. No.: US 2026/0188877 A1
(43) Pub. Date: Jul. 2, 2026

(54) SECONDARY BATTERY

(71) Applicant: KABUSHIKI KAISHA TOSHIBA, Kawasaki-shi (JP)

(72) Inventor: Naoki IWAMURA, Kamakura Kanagawa (JP)

(73) Assignee: KABUSHIKI KAISHA TOSHIBA, Kawasaki-shi (JP)

(21) Appl. No.: 19/550,482

(22) Filed: Feb. 26, 2026

Related U.S. Application Data
(63) Continuation of application No. PCT/JP2025/002786, filed on Jan. 29, 2025.

(30) Foreign Application Priority Data
Sep. 30, 2024 (JP) 2024-169948

(51) Int. Cl. H01M 50/591; H01M 10/0587; H01M 50/533; H01M 50/536; H01M 50/538; H01M 50/586

(52) U.S. Cl. CPC H01M 50/591; H01M 10/0587; H01M 50/533; H01M 50/536; H01M 50/538; H01M 50/586

(57) ABSTRACT

According to one embodiment, a secondary battery includes an electrode assembly including a positive electrode, a negative electrode, and a plurality of current collector tabs extending from the positive electrode and the negative electrode and provided at least one end of the electrode assembly, and an outer case accommodating the electrode assembly. The current collector tabs include a first clamped portion whose tip end is clamped by an insulating cover and an extending portion provided from the first clamped portion toward the one end of the electrode assembly and covered with the insulating cover.

### CROSS-REFERENCE TO RELATED APPLICATIONS

This application is a Continuation Application of PCT Application No. PCT/JP2025/002786, filed Jan. 29, 2025 and based upon and claiming the benefit of priority from Japanese Patent Application No. 2024-169948, filed Sep. 30, 2024, the entire contents of which are incorporated herein by reference.

### FIELD

Embodiments described herein relate generally to a secondary battery.

### BACKGROUND

Secondary batteries such as lead-acid batteries and nickel metal hydride batteries have been known as typical power sources used for electric vehicles, hybrid cars, electric motorcycles, forklifts, and the like. Recently, development toward adoption of lithium-ion secondary batteries with high energy density has intensified, with further development conducted in view of long cycle life and safety.

One form of a general lithium-ion secondary battery (hereinafter referred to as “secondary battery”) includes a secondary battery comprising an outer case, an electrode assembly accommodated in the outer case, current collector tabs extending from the electrode assembly, and positive and negative leads joined to the respective current collector tabs. Such secondary batteries serve various applications. For example, when the secondary battery is mounted on a vehicle, vehicle running causes vibration of the secondary battery. If the electrode assembly in the secondary battery were to displace with the vibration and the current collector tab or the leads were to contact the outer case, the secondary battery could short-circuit.

Further, high capacity is generally required for secondary batteries. As means to increase capacity, one may enlarge the dimensions of the electrode assembly or increase the number of windings of the electrodes to increase the mass of the electrode active material. These means increase the weight of the electrode assembly. The above vibration grows with the mass of the electrode assembly, and the displacement of the electrode assembly may cause a short circuit of the secondary battery.

### BRIEF DESCRIPTION OF DRAWINGS

FIG. 1 is a perspective view schematically showing a secondary battery of the first embodiment.

FIG. 2 is an exploded perspective view schematically showing the secondary battery of the first embodiment in a state disassembled by component.

FIG. 3 is a perspective view schematically showing the configuration around an electrode assembly used in the secondary battery of the first embodiment.

FIG. 4 is a cross-sectional view showing a cross section along line I-I of FIG. 3 as viewed from the arrow direction.

FIG. 5 is a first perspective view schematically showing an insulating cover used in the secondary battery of the first embodiment from a viewpoint of a current collector tab 70.

FIG. 6 is a second perspective view schematically showing the insulating cover used in the secondary battery of the first embodiment from a viewpoint opposite to FIG. 5.

FIG. 7 is a first front view schematically showing the configuration around the electrode assembly used in the secondary battery of the first embodiment.

FIG. 8 is a perspective view schematically showing the first modified example of the insulating cover used in the secondary battery of the first embodiment.

FIG. 9 is a cross-sectional view showing a cross section along line I-I of FIG. 3 when the insulating cover of the first modified example is used as viewed from the arrow direction.

FIG. 10 is a perspective view schematically showing the second modified example of the insulating cover used in the secondary battery of the first embodiment.

FIG. 11 is a cross-sectional view showing a cross section along line I-I of FIG. 3 when the insulating cover of the second modified example is used as viewed from the arrow direction.

FIG. 12 is a second front view schematically showing the configuration around the electrode assembly used in the secondary battery of the first embodiment.

### DETAILED DESCRIPTION

Various embodiments will be described hereinafter with reference to the accompanying drawings. In general, according to one embodiment, A secondary battery, comprises an electrode assembly including a positive electrode, a negative electrode, and a plurality of current collector tabs extending from the positive electrode and the negative electrode and provided at least one end of the electrode assembly; an outer case accommodating the electrode assembly; and an insulating cover covering the current collector tabs. The current collector tabs include a first clamped portion whose tip end is clamped by the insulating cover and an extending portion provided between the first clamped portion and the one end of the electrode assembly and covered with the insulating cover.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc. of the respective parts are schematically illustrated in the drawings, compared to the actual modes. However, the schematic illustration is merely an example, and adds no restrictions to the interpretation of the invention. In addition, in the specification and drawings, the same elements as those described in connection with preceding drawings are denoted by like reference numbers, and detailed description thereof is omitted or simplified unless necessary.

### First Embodiment

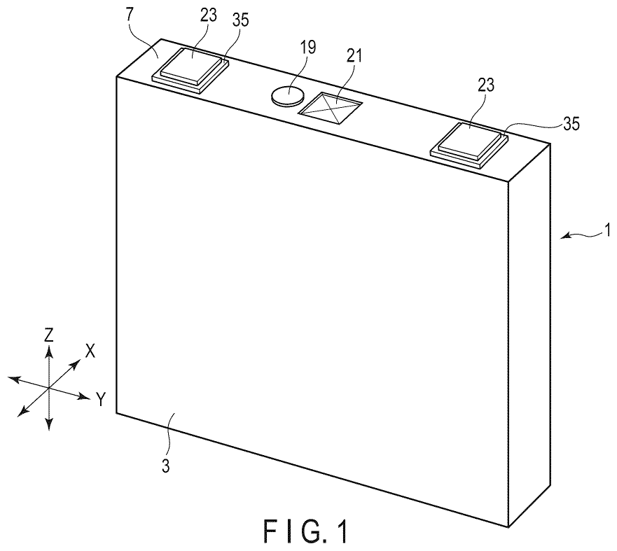

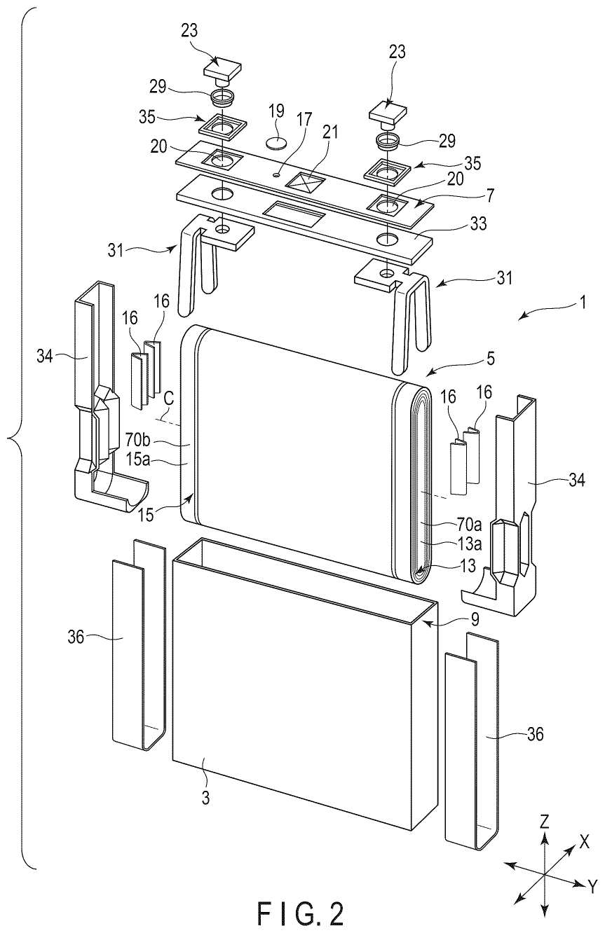

The following will describe a secondary battery 1 of the first embodiment with reference to FIG. 1 and FIG. 2.

FIG. 1 is a perspective view schematically showing the secondary battery 1 of the first embodiment. FIG. 2 is an exploded perspective view schematically showing the secondary battery 1 of the first embodiment in a state disassembled by component.

As shown in FIG. 1 and FIG. 2, the secondary battery 1 includes an outer case 3 and an electrode assembly 5. For example, the outer case 3 has a tubular shape with side walls and a bottom wall. The outer case 3 has an internal cavity therein. An aperture portion 9 is provided at the upper portion of the outer case 3. For example, a lid member 7 is provided in the aperture portion 9. The outer case 3 and the lid member 7 are formed of a metal such as aluminum, an aluminum alloy, iron, copper, or stainless steel. The secondary battery 1 only needs to include the outer case 3 and the electrode assembly 5. The outer case 3 is not limited to a tubular shape. The bottom wall and the aperture portion 9 of the outer case 3 are not limited to a rectangular shape and may have other shapes.

The electrode assembly 5 is accommodated in the internal cavity of the outer case 3. The electrode assembly 5 is manufactured, for example, by winding a positive electrode 13, a negative electrode 15, and a separator (not shown) interposed between the positive electrode 13 and the negative electrode 15 around a winding axis C and then pressing the whole to form a flat shape. That is, the electrode assembly 5 has a wound structure in the present embodiment.

The positive electrode 13 includes a positive current collector 13a and a positive active material supporter portion (not shown) supported on one or both faces of the positive current collector 13a. Here, the positive current collector 13a is a metal foil. The positive current collector 13a comprises a positive current collector tab 70a as a part where the positive active material supporter portion is not coated.

In contrast, the negative electrode 15 includes a negative current collector 15a and a negative active material supporter portion (not shown) supported on one or both faces of the negative current collector 15a. Here, the negative current collector 15a is a metal foil. The negative current collector 15a includes a negative current collector tab 70b as a part where the negative active material supporter portion is not coated.

The positive current collector tab 70a and the negative current collector tab 70b are sometimes collectively referred to as current collector tabs 70. The electrode assembly 5 is not limited to the wound structure and may have a stack structure manufactured by alternately stacking the plurality of positive electrodes 13 and the plurality of negative electrodes 15 with separators interposed therebetween. When the electrode assembly 5 having the stack structure is employed, the connection structure with the outer case is modified as appropriate. The electrode assembly 5 is not limited to the wound structure and the stack structure.

In the present embodiment, the electrode assembly 5 is a wound body. A plurality of collector tabs 70 extending from the positive electrode 13 and the negative electrode 15 are provided at least at one end of the electrode assembly 5. In the present embodiment, the positive current collector tab 70a is provided at one end in the direction of the winding axis C of the electrode assembly 5, and the negative current collector tab 70b is provided at the other end in the direction of the winding axis C. The positive current collector tab 70a and the negative current collector tab 70b extend in a direction orthogonal to the accommodating direction of the electrode assembly 5 into the outer case 3 (the Z-direction). The positive current collector tab 70a extends in a direction opposite to the extension direction of the negative current collector tab 70b.

The extension directions of the positive current collector tab 70a and the negative current collector tab 70b are not limited to these directions. For example, both of the current collector tabs 70a and 70b may extend in the same direction and be provided at one end of the electrode assembly 5.

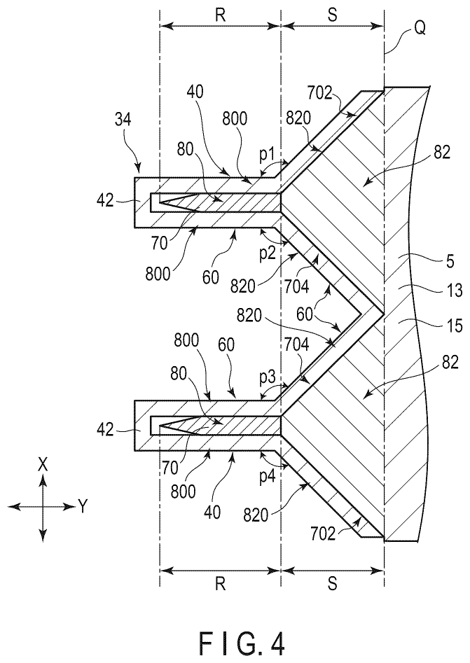

When the electrode assembly 5 having the wound structure is used and the wound collector tabs 70 are provided at both ends in the direction of the winding axis C as in the present embodiment, the tip ends of the current collector tabs 70 are preferably clamped by two or more conductive members 16 as shown in FIG. 4. Here, clamping signifies that the conductive member 16 bundles and integrates the plurality of current collector tabs 70. At least part of the conductive member 16 needs to contact one face and the other face of the current collector tab 70. Stable clamping of the current collector tabs 70 by the conductive members 16 is thereby achieved even when, for example, the weight of the electrode assembly 5 is increased as a means to increase the capacity of the secondary battery 1. Here, increasing the weight of the electrode assembly 5 includes enlarging the dimensions of the electrode assembly or increasing the number of windings of the electrodes to increase the mass of the electrode active material. The number of the conductive members 16 provided for each of the current collector tabs 70 at the respective ends of the electrode assembly 5 is not limited to these examples. At least one of the current collector tabs 70 at the respective ends of the electrode assembly 5 is preferably clamped by one or more conductive members 16.

The positive electrode 13 is manufactured by coating a slurry containing a positive active material on the positive current collector 13a formed of an aluminum foil or an aluminum-alloy foil. Examples of positive active materials include oxides, sulfides, and their polymers capable of absorbing and desorbing of lithium ion. The positive active materials are not limited to these examples. Preferred positive active materials include lithium- manganese composite oxides, lithium-nickel composite oxides, lithium-cobalt composite oxides, lithium iron phosphate, and the like.

The negative electrode 15 is produced by coating a slurry containing a negative active material on the negative current collector 15a formed of, for example, an aluminum foil, an aluminum-alloy foil, or a copper foil. Negative active materials include metal oxides, metal sulfides, metal nitrides, and carbon materials capable of absorbing and desorbing of lithium ion. The negative active materials are not limited to these examples. Preferred negative active materials include titanium oxides, lithium titanium oxide, niobium titanium oxides, niobium oxides, tungsten oxides, amorphous tin oxides, tin-silicon oxides, silicon oxides, silicon, and the like.

Inside the outer case 3, an electrolyte (not shown) impregnates the electrode assembly 5. For example, the electrolyte is injected into the interior of the outer case 3 through a liquid injection port 17 provided in the lid member 7. The liquid injection port 17 is closed by a sealing plate 19 after electrolyte injection. A nonaqueous electrolyte prepared by dissolving an electrolyte (for example, a lithium salt) in a nonaqueous solvent is used as the electrolyte. The nonaqueous solvent may be used alone or as a mixture of two or more.

A gas vent valve 21 is formed on the surface of the lid member 7 together with the liquid injection port 17. The liquid injection port 17 and the gas vent valve 21 need not be provided on the lid member 7. For example, a pair of external terminals 23 are mounted on the surface of the lid member 7. The external terminal 23 is formed of a conductive material such as a metal. The external terminals 23 are provided in close contact with the lid member 7 via insulating gaskets 29 and each are connected to leads 31.

Preferably, the electrode assembly 5 is electrically connected to the external terminals 23 by joining the leads 31 to the conductive members 16 clamping the current collector tabs 70. Joining the leads 31 to the conductive members 16 suppresses tearing of the current collector tabs 70 at the time of joining than directly joining the leads 31 to the current collector tabs 70.

An internal insulating member 33 may be provided between the lid member 7 and the leads 31. In this case, the internal insulating member 33 electrically insulates the lid member 7 and the leads 31 from each other. A terminal insulator 35 may be further provided between the external terminals 23 and the lid member 7. In this case, the terminal insulator 35 electrically insulates the external terminals 23 and the lid member from each other.

In the present embodiment, an insulating cover 34 covering the current collector tabs 70 is provided between the current collector tabs 70 and the outer case 3. The insulating cover 34 electrically insulates the current collector tab 70 from the outer case 3. The insulating cover 34 is fixed to the electrode assembly 5 by an insulating tape 36.

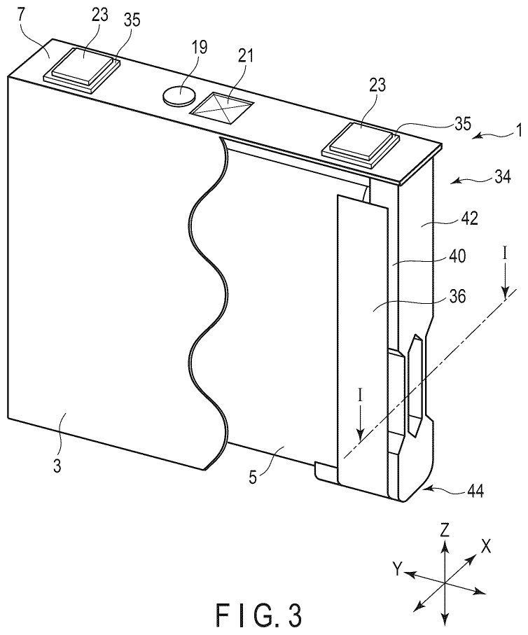

The following will describe the configuration around the electrode assembly 5 when the current collector tabs 70 are covered with the insulating cover 34 with reference to FIG. 3. Further, the following will describe the configuration in which the current collector tabs 70 are covered with the insulating cover 34 with reference to FIG. 4. FIG. 3 is a perspective view schematically showing the configuration around the electrode assembly 5 used in the secondary battery 1 of the first embodiment. FIG. 4 is a cross-sectional view showing a cross section along line I-I of FIG. 3 as viewed from the arrow direction.

As shown in FIG. 3 and FIG. 4, the insulating cover 34 covers the current collector tabs 70 and clamps the tip ends of the current collector tabs 70. Here, a part of the current collector tab 70 clamped by the insulating cover 34 is referred to as a first clamped portion 80. The tip end of the current collector tab 70 corresponds to an area R in FIG. 4, which is an area where part of the insulating cover 34 is provided in parallel in the X-direction in FIG. 4. Here, clamping means that at least part of the tip end (the area R) of the current collector tab 70 contacts part of the insulating cover 34 provided in parallel in the X-direction.

A part of the current collector tab 70 provided from the first clamped portion 80 toward the one end (a line Q) of the electrode assembly 5 (a part provided in an area S) is defined as an extending portion 82. As shown in FIG. 4, the extending portion 82 is covered with the insulating cover 34 in the same manner as the first clamped portion 80. Here, the one end of the electrode assembly 5 is the line Q, which is the boundary between the positive electrode 13 and the negative electrode 15 and the current collector tabs 70 provided to extend from the positive electrode 13 and the negative electrode 15.

When the electrode assembly 5 includes the wound collector tabs 70 at both ends in the direction of the winding axis C as the electrode assembly 5 in the present embodiment, the first clamped portion 80 and the extending portion 82 of the current collector tab 70 are provided between an innermost peripheral portion 704 and an outermost peripheral portion 702 in the winding of the current collector tabs 70 as shown in FIG. 4. The insulating cover 34 therefore covers both of the innermost peripheral portion 704 and the outermost peripheral portion 702 of the current collector tabs 70.

In the secondary battery 1 of the present embodiment, the current collector tab 70 includes the first clamped portion 80 clamped by the insulating cover 34 and the extending portion 82 covered with the insulating cover 34. Thus, even if vehicle running causes vibration of the secondary battery 1, the insulating cover 34 can suppress displacement of the current collector tab 70. This configuration can prevent contact between the current collector tab 70 and the outer case 3 and thus can prevent short circuit of the secondary battery 1.

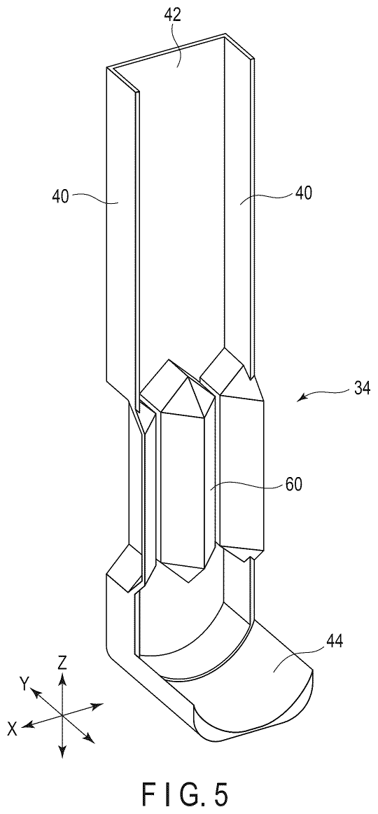

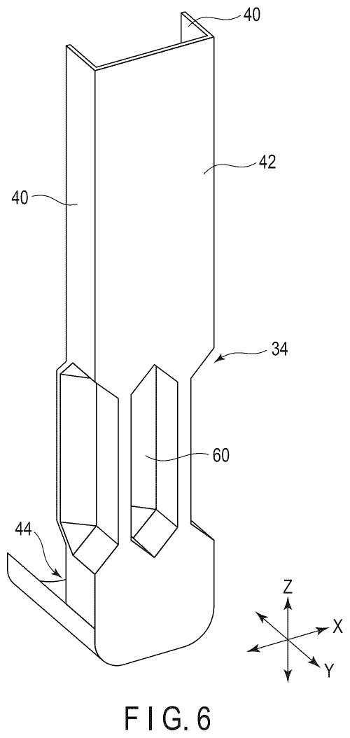

The following will describe the configuration of the insulating cover 34 with reference to FIG. 5 and FIG. 6. FIG. 5 is the first perspective view schematically showing the insulating cover 34 used in the secondary battery 1 of the first embodiment from the current collector tab 70 side. FIG. 6 is the second perspective view schematically showing the insulating cover 34 from the side opposite to FIG. 5.

As shown in FIG. 5 and FIG. 6, the insulating cover 34 includes a U-shaped member 40 having a pair of side walls, a back member 42 connected to the U-shaped member 40, and a bottom member 44 extending from the U-shaped member 40 and the back member 42. The insulating cover 34 further includes a protruding portion 60 protruding from the back member 42. The insulating cover 34 covers the current collector tabs 70. As described above, the current collector tabs 70 only need to be electrically insulated from the outer case 3. The bottom member 44 of the insulating cover 34 may be omitted.

The U-shaped member 40 and the bottom member 44 of the insulating cover 34 are provided in contact with the outermost peripheral portion 702 of the current collector tabs 70. Here, “contact” means that at least part of the U-shaped member 40 and the bottom member 44 contact the outermost peripheral portion 702 of the current collector tabs 70. The protruding portion 60 of the insulating cover 34 is inserted into the innermost peripheral portion 704 of the current collector tab 70 and is provided in contact with the innermost peripheral portion 704. Here, “contact” means that at least part of the protruding portion 60 contacts the innermost peripheral portion 704 of the current collector tab 70.

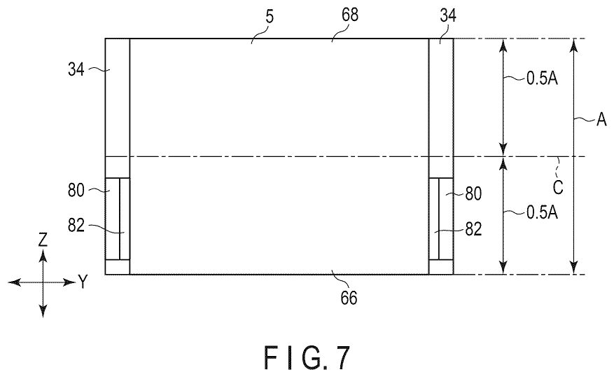

The current collector tab 70 includes the first clamped portion 80 and the extending portion 82 both covered with the insulating cover 34. The following will describe the positions of the first clamped portion 80 and the extending portion 82 with reference to FIG. 7. FIG. 7 is the first front view schematically showing the configuration around the electrode assembly 5 used in the secondary battery 1 of the first embodiment. As shown in FIG. 7, at least part of the first clamped portion 80 and the extending portion 82 of the current collector tabs 70 is preferably provided in an area of height 0.5 A from a bottom portion 66 toward a top portion 68 with respect to a height A of the electrode assembly 5 in the accommodating direction (Z) of the electrode assembly 5. Furthermore, in the present embodiment, at least part of the first clamped portion 80 and the extending portion 82 of the current collector tab 70 need to be provided in the area of height 0.5 A from the bottom portion 66 toward the top portion 68 of the electrode assembly 5. This is because displacement of the current collector 70 due to vibration of the secondary battery 1 occurs more readily in the area of height 0.5 A from the bottom portion 66 toward the top portion 68 of the electrode assembly 5 than in an area of height from 0.5 A to A from the bottom portion 66 toward the top portion 68 of the electrode assembly 5.

The following will describe the insulating cover 34 of the present embodiment again in more detail with reference to FIG. 4. As shown in FIG. 4, angles p (p1, p2, p3, and p4) formed between a first contact portion 800 contacting the first clamped portion 80 and a second contact portion 820 contacting the extending portion 82 of the current collector tab 70 are preferably within a range of 105° or greater and 165° or less in the insulating cover 34. The first contact portion 800 is a part clamping the first clamped portion 80 of the current collector tab 70 in the insulating cover 34. The second contact portion 820 is a part covering the extending portion 82 of the current collector tab 70 in the insulating cover 34. The configuration in which the angles p (p1, p2, p3, and p4) are 105° or greater can suppress pulling of the current collector tab 70 at the outermost peripheral portion 702 and the innermost peripheral portion 704 at the one end (the line Q) of the electrode assembly 5 by the insulating cover 34 clamping the first clamped portion 80 of the current collector tab 70 and resultant breakage. Further, the configuration in which the angles p (p1, p2, p3, and p4) are 165° or less makes the angle formed by the protruding portion 60 relative to the insertion direction into the innermost peripheral portion 704 of the current collector tab 70 sharp. Thus, this configuration facilitates insertion of the protruding portion 60 into the innermost peripheral portion 704 of the current collector tab 70.

In the insulating cover 34, the angles p (p1, p2, p3, and p4) formed between the first contact portion 800 contacting the first clamped portion 80 and the second contact portion 820 contacting the extending portion 82 of the current collector tab 70 are preferably within a range of 120° or greater and 150° or less. The configuration in which the angles p (p1, p2, p3, and p4) are 120° or greater can suppress pulling of the current collector tab 70 at the outermost peripheral portion 702 and the innermost peripheral portion 704 at the one end (line Q) of the electrode assembly 5 by the insulating cover 34 clamping the first clamped portion 80 of the current collector tab 70 and resultant breakage. The configuration in which the angles p (p1, p2, p3, and p4) are 150° or less can facilitate the insertion of the protruding portion 60 of the insulating cover 34 into the innermost peripheral portion 704 of the current collector tab 70 and facilitate contact between the insulating cover 34 and the extending portion 82 of the current collector tab 70.

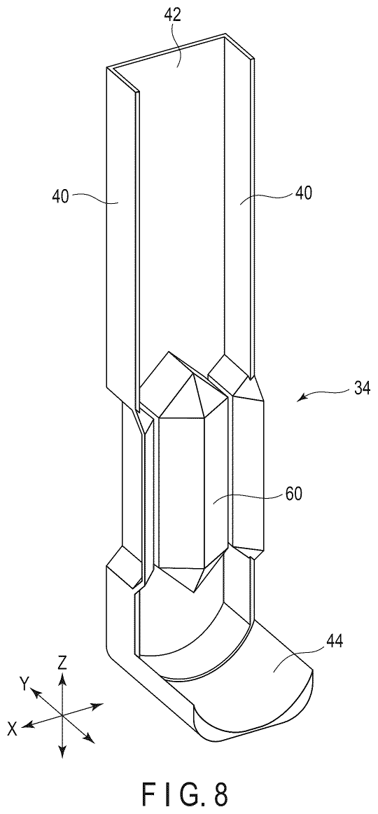

As shown in FIG. 4, the insulating cover 34 includes the plurality of first contact portions 800 contacting the first clamped portion 80 and the plurality of second contact portions 820 contacting the extension portion 82 of the current collector tab 70. Thus, the plurality of angles p (p1, p2, p3, and p4) formed between the first contact portion 800 contacting the first clamped portion 80 and the second contact portion 820 contacting the extending portion 82 are provided. These plurality of angles p (p1, p2, p3, and p4) are preferably equivalent to each other. The configuration in which the angles p (p1, p2, p3, and p4) are equivalent to each other enable uniform suppression of displacement of the current collector tab 70 at each of the first contact portions 800 and at each of the second contact portions 820, for example, even when the secondary battery 1 vibrates during vehicle running. In the insulating cover 34 of FIG. 8, the angles p (p1, p2, p3, and p4) are 135° and thus are equivalent to each other.

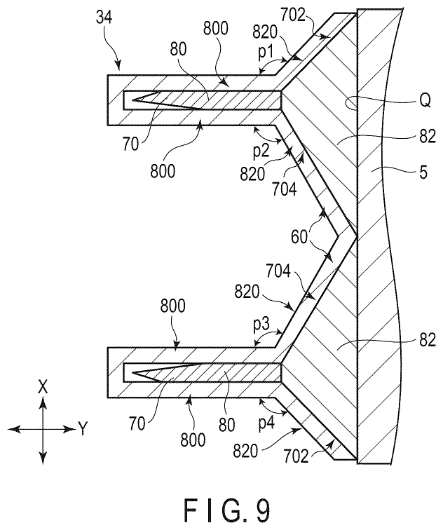

The angles p (p1, p2, p3, and p4) formed between the first contact portion 800 contacting the first clamped portion 80 of and the second contact portion 820 contacting the extending portion 82 the current collector tab 70 may differ from each other. The following will describe the first modified example of the insulating cover 34 of the present embodiment with reference to FIG. 8 and FIG. 9. FIG. 8 is a perspective view schematically showing the first modified example of the insulating cover 34 used in the secondary battery 1 of the first embodiment. FIG. 9 is a cross-sectional view showing a cross section along line I-I of FIG. 3 when the insulating cover 34 of the first modified example is used as viewed from the arrow direction. The insulating cover 34 of the first modified example differs from the insulating cover 34 shown in FIG. 5 and FIG. 6 in the angles p (p1, p2, p3, and p4) formed between the first contact portion 800 and the second contact portion 820.

In the insulating cover 34 in the first modified example, the angles p1 and p4 formed between the first contact portion 800 contacting the outermost peripheral portion 702 of the current collector tab 70 and the second contact portion 820 are greater than the angles p2 and p3 formed between the first contact portion 800 contacting the innermost peripheral portion 704 of the current collector tab 70 and the second contact portion 820. This configuration can suppress pulling by the insulating cover 34 clamping the first clamped portion 80 of the current collector 70 at the outermost peripheral portion 702 of the current collector tab 70 at the one end (line Q) of the electrode assembly 5 more than at the innermost peripheral portion 704. Thus, the breakage of the outermost peripheral portion 702 of the current collector tab 70 can be suppressed. In one example of the insulating cover 34 in FIG. 9, the angles p1 and p4 are 135°, and the angles p2 and p3 are 120°.

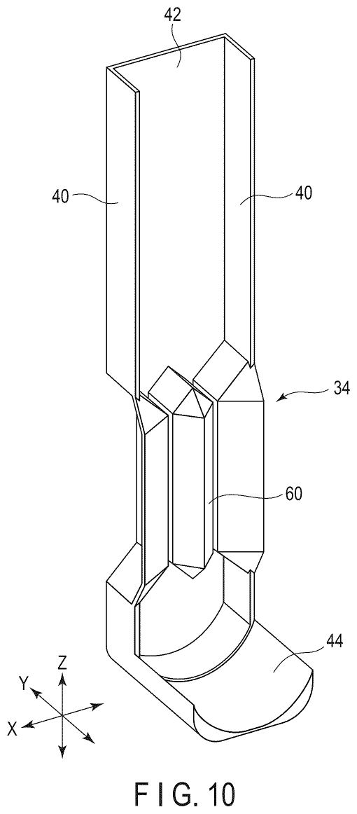

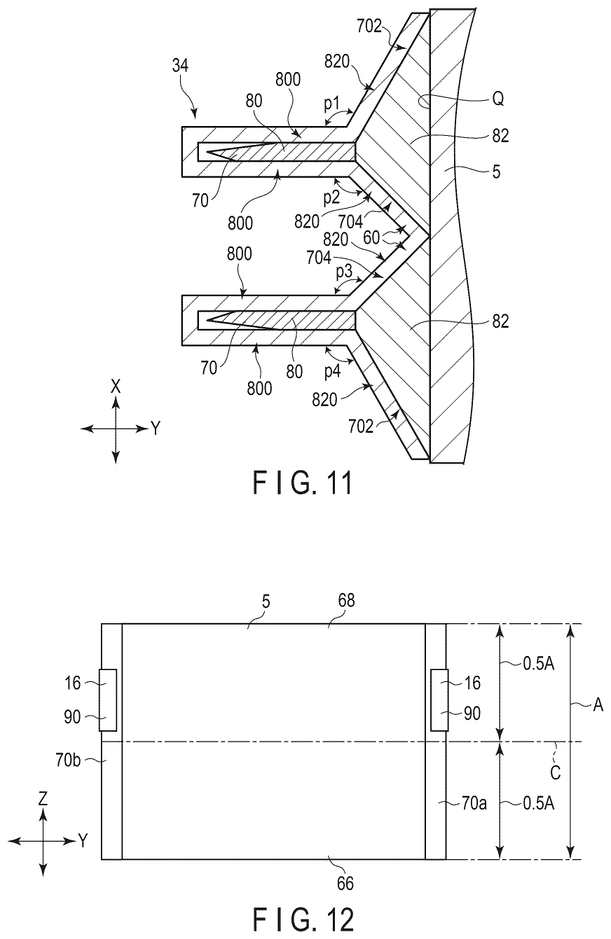

The following will describe the second modified example of the insulating cover 34 in the present embodiment with reference to FIG. 10 and FIG. 11. FIG. 10 is a perspective view schematically showing the second modified example of the insulating cover 34 used in the secondary battery 1 of the first embodiment. FIG. 11 is a cross-sectional view showing a cross section along line I-I of FIG. 3 when the insulating cover 34 of the second modified example is used as viewed from the arrow direction. The insulating cover 34 of the second modified example differs from the insulating cover 34 shown in FIGS. 5 and 6 in the angles p (p1, p2, p3, and p4) formed between the first contact portion 800 contacting the first clamped portion 80 and the second contact portion 820 contacting the extending portion 82.

In the insulating cover 34 of the second modified example, the angles p2 and p3 formed by the first contact portion 800 contacting the first clamped portion 80 and the second contact portion 820 contacting the innermost peripheral portion 704 on the side of the innermost peripheral portion 704 of the current collector tab 70 are greater than the angles p1 and p4 formed by the first contact portion 800 contacting the first clamped portion 80 and the second contact portion 820 contacting the outermost peripheral portion 702 on the side of the outermost peripheral portion 702 of the current collector tab 70. This configuration can suppress pulling by the insulating cover 34 clamping the first clamped portion 80 of the current collector tab 70 at the innermost peripheral portion 704 of the current collector tab 70 at the one end (line Q) of the electrode assembly 5 more than at the outermost peripheral portion 702. Thus, the breakage of the innermost peripheral portion 704 of the current collector tab 70 is suppressed. Further, the configuration in which the angles p2 and p3 are greater than the angles p1 and p4 causes the protruding portion 60 to have a sharper angle and facilitates insertion of the protruding portion 60 into the innermost peripheral portion 704 of the current collector tab 70. In one example, the angles p1 and p4 are 120° and the angles p2 and p3 are 135° in the insulating cover 34 in FIG. 11.

In the first modified example and the second modified example, the angles p1 and p4 are equivalent to each other and the angles p2 and p3 are equivalent to each other. These angles p (p1, p2, p3, and p4) may differ from each other.

Furthermore, in the present embodiment, at least part of the first clamped portion 80 and the extending portion 82 of the current collector tab 70 are preferably provided in the area of height 0.5 A from the bottom portion toward the top portion of the electrode assembly 5. In this case, more preferably, the lead 31 is joined to the conductive member 16 clamping the tip end portion of the current collector tab 70. A part clamped by the conductive member 16 at the tip end portion of the current collector tab 70 is referred to as a second clamped portion 90. The following will describe the position where the conductive member 16 joined to the lead 31 is provided with reference to FIG. 12.

FIG. 12 is the second front view schematically showing the configuration around the electrode assembly 5 used in the secondary battery 1 of the first embodiment. As shown in FIG. 12, at least part of the second clamped portion 90 of the current collector tab 70 is preferably provided in an area of height from 0.5 A to A from the bottom portion 66 toward the top portion 68 of the electrode assembly 5 with respect to the height A in the accommodating direction (Z) of the electrode assembly 5. As described above, the lead 31 is electrically connected not only to the conductive member 16 but also to the external terminal 23. From the viewpoint of conductive properties, the lead 31 is preferably provided at a position close to the external terminal 23. The conductive member 16 is therefore preferably provided in the area of height from 0.5 A to A from the bottom portion 66 toward the top portion 68 of the electrode assembly 5 with respect to the height A. Thus, electric energy can be taken out from the electrode assembly 5 via the lead 31 at a position close to the external terminal 23, and thus high conductive properties can be obtained. The lead 31 may be electrically connected directly to the current collector tab 70 without the conductive member 16. Even when the lead 31 is directly connected to the current collector tab 70, the lead 31 is preferably connected to the current collector tab 70 in the area of height from 0.5 A to A from the bottom portion 66 toward the top portion 68 of the electrode assembly 5.

Even when the secondary battery 1 vibrates, this configuration can suppress displacement of the current collector tab 70 by the conductive member 16 or the lead 31 in the area of height from 0.5 A to A from the bottom portion 66 toward the top portion 68 of the electrode assembly 5. Further, using the insulating cover 34 of the present embodiment can suppress displacement of the current collector tab 70 even in the area of height 0.5 A from the bottom portion 66 toward the top portion 68 of the electrode assembly 5, namely even in the area where displacement of the current collector tab 70 readily occurs. Thus, displacement of the current collector tab 70 due to vibration of the secondary battery 1 can be suppressed over the entire area from the bottom portion 66 toward the top portion 68 of the electrode assembly 5.

Even when the mass of the electrode assembly 5 increases by enlarging the dimensions of the electrode assembly 5 or by increasing the number of windings of the electrode assembly 5, the conductive member 16 and the insulating cover 34 can suppress the displacement of the current collector tab 70.

According to at least one embodiment of the secondary battery 1 described above, the current collector tab 70 includes the first clamped portion 80 clamped by the insulating cover 34 and the extending portion 82 covered with the insulating cover 34. Thus, the configuration in which the current collector tab 70 includes the first clamped portion 80 clamped by the insulating cover 34 and the extending portion 82 covered with the insulating cover 34 can suppress the displacement of the current collector tab 70 using the insulating cover 34, for example, even if the secondary battery 1 vibrates due to vehicle running. Suppressing displacement of the current collector tab 70 by the insulating cover 34 can prevent contact between the current collector tab 70 and the outer case 3 and a resultant short circuit of the secondary battery 1. Thus, the secondary battery 1 with high safety and excellent vibration resistance can be provided.

Even when the mass of the electrode assembly 5 increases along with capacity increase of the secondary battery 1 by enlarging the dimensions of the electrode assembly 5 or by increasing the number of windings of the electrode assembly 5, displacement of the current collector tab 70 can be suppressed not only by the conductive member 16 but also by the insulating cover 34. This configuration can prevent a short circuit of the secondary battery 1 resulting from contact between the current collector tab 70 and the outer case 3. Thus, the secondary battery 1 with high safety and excellent vibration resistance can be provided.

While certain embodiments have been described, these embodiments have been presented by way of example only, and are not intended to limit the scope of the inventions. These embodiments can be implemented in various other forms, and various omissions, substitutions, and modifications can be made to the extent that they do not depart from the gist of the invention. These embodiments and variations thereof are included in the scope and gist of the invention as well as in the claims and their equivalents.

For example, the electrode assembly is not limited to a so-called wound type electrode formed by winding electrode plates but may be a so-called stack type electrode assembly formed by stacking a plurality of electrode plates in the thickness direction. Materials, shapes, and sizes of elements constituting the secondary battery are not limited to the embodiments described above and can be changed as needed.

What is claimed is:

1. A secondary battery, comprising:
an electrode assembly including a positive electrode, a negative electrode, and a plurality of current collector tabs extending from the positive electrode and the negative electrode and provided at least one end of the electrode assembly;
an outer case accommodating the electrode assembly; and
an insulating cover covering the current collector tabs, wherein
the current collector tabs include a first clamped portion whose tip end is clamped by the insulating cover and an extending portion provided between the first clamped portion and the one end of the electrode assembly and covered with the insulating cover.

2. The secondary battery of claim 1, wherein
the electrode assembly is configured by winding the positive electrode and the negative electrode around a winding axis,
the electrode assembly includes the current collector tabs respectively extending from one end and the other end in a direction of the winding axis, and
the first clamped portion and the extending portion are respectively provided at an innermost peripheral portion and an outermost peripheral portion in the winding of the current collector tabs.

3. The secondary battery of claim 2, wherein
the insulating cover includes a protrusion portion inserted between the plurality of current collector tabs and provided in the innermost peripheral portion.

4. The secondary battery of claim 1, wherein
the current collector tabs extend in a direction orthogonal to an accommodating direction of the electrode assembly into the outer case, and
at least part of the first clamped portion and the extending portion of the current collector tabs is provided in an area of height 0.5 A from a bottom portion toward a top portion of the electrode assembly with respect to a height A of the electrode assembly in the accommodating direction of the electrode assembly into the outer case.

5. The secondary battery of claim 1, wherein
the insulating cover includes a first contact portion contacting the first clamped portion and a second contact portion contacting the extending portion of the current collector tab, and
an angle formed between the first contact portion and the second contact portion is within a range of 105° or greater and 165° or less.

6. The secondary battery of claim 1, wherein
the insulating cover includes a first contact portion contacting the first clamped portion and a second contact portion contacting the extending portion of the current collector tab, and
an angle formed between the first contact portion and the second contact portion is within a range of 120° or greater and 150° or less.

7. The secondary battery of claim 5, wherein
the insulating cover includes a plurality of sets of a first contact portion contacting the first clamped portion and a second contact portion contacting the extending portion of the current collector tabs, and
angles formed between the first contact portion and the second contact portion of the sets are equivalent to each another.

8. The secondary battery of claim 4, wherein
the current collector tabs include a second clamped portion clamped by a conductive member at a tip end portion of the current collector tabs, between the insulating cover and the current collector tabs, and
when the height from the bottom portion to the top portion of the electrode assembly is A, at least part of the conductive member and the second clamped portion is provided in an area of height from 0.5 A to A from the bottom portion toward the top portion of the electrode assembly.
